(19) United States
(12) Patent Application Publication
(10) Pub. No.: US 2025/0237924 A1
(43) Pub. Date: Jul. 24, 2025

(54) RIB WAVEGUIDES FOR TRANSVERSE-MAGNETIC POLARIZATION SILICON-PHOTONIC MODULATOR

(71) Applicant: Aloe Semiconductor Inc., Middletown, NJ (US)

(72) Inventor: Christopher R. Doerr, MIddletown, NJ (US)

(21) Appl. No.: 18/419,094

(22) Filed: Jan. 22, 2024

(51) Int. Cl. G02F 1/225; G02F 1/21

(52) U.S. Cl. CPC G02F 1/2257; G02F 1/212

(57) ABSTRACT

A silicon-photonic optical modulator includes an optical input; and an optical waveguide that is connected to the optical input and that is configured to propagate quasi-transverse-magnetic (quasi-TM) polarized light. The optical waveguide is configured as a rib waveguide that includes a rib arranged on a slab. The rib includes at least one dopant. An average concentration of the at least one dopant in a vertical doping profile in a lowermost portion of the rib is larger than an average concentration of the at least one dopant in the vertical doping profile in an uppermost portion of the rib. The uppermost portion of the rib has a height that is between 20% and 80% of a height of the rib waveguide. The lowermost portion of the rib includes a remainder of the rib below the uppermost portion.

### TECHNICAL FIELD

The present disclosure generally relates to electro-optical modulators in silicon photonics.

### BACKGROUND

In optical communication systems, electro-optical modulators provide a fundamental mechanism of modulating optical waveforms to carry information. In general, electro-optical modulators operate by modifying one or more properties of optical waveforms according to information, such as digital data, provided by electrical signals.

### SUMMARY

Implementations of the present disclosure are generally directed to electro-optical modulators in silicon photonics. Some aspects of this disclosure relate to a silicon-photonic optical modulator that includes an optical input and an optical waveguide that is connected to the optical input and that is configured to propagate quasi-transverse-magnetic (quasi-TM) polarized light. The optical waveguide is configured as a rib waveguide that includes a rib arranged on a slab. The rib includes at least one dopant. An average concentration of the at least one dopant in a vertical doping profile in a lowermost portion of the rib is larger than an average concentration of the at least one dopant in the vertical doping profile in an uppermost portion of the rib. The uppermost portion of the rib has a height that is between 20% and 80% of a height of the rib waveguide. The lowermost portion of the rib includes a remainder of the rib below the uppermost portion.

Implementations of this and other modulators discussed herein can have one or more of at least the following characteristics.

In some implementations, the average concentration of the at least one dopant in the lowermost portion is at least 1.5 times the average concentration of the at least one dopant in the uppermost portion.

In some implementations, the average concentration of the at least one dopant in the lowermost portion is at least two times the average concentration of the at least one dopant in the uppermost portion.

In some implementations, the height of the uppermost portion is between 35% and 65% of the height of the rib waveguide.

In some implementations, the average concentration of the at least one dopant in the lowermost portion is between 10¹⁷ cm⁻³ and 10¹⁸ cm⁻³, and the average concentration of the at least one dopant in the uppermost portion is less than 5×10¹⁶ cm⁻³.

In some implementations, the at least one dopant includes a first dopant in a first lateral portion of the rib and a second dopant in a second lateral portion of the rib, the second lateral portion opposite the first lateral portion. The first lateral portion and the second lateral portion form a semiconductor junction diode.

In some implementations, a concentration of the first dopant in a first vertical doping profile in the first lateral portion of the rib is higher in the lower portion of the rib than in the upper portion of the rib, and a concentration of the second dopant in a second vertical doping profile in the second lateral portion of the rib is higher in the lower portion of the rib than in the upper portion of the rib.

In some implementations, the silicon-photonic optical modulator includes an electrode configured to apply an electric field to the semiconductor junction diode.

In some implementations, the silicon-photonic optical modulator includes a semiconductor contact region to which the electrode makes contact. A height of the semiconductor contact region is greater than a height of the slab.

In some implementations, an effective refractive index of a TM polarization two-dimensional (2D) guided mode in the rib waveguide is greater than all effective refractive indexes of transverse-electric (TE) polarization one-dimensional (1D) guided modes in the slab.

In some implementations, the optical waveguide is a first optical waveguide. The silicon-photonic optical modulator includes a Mach-Zehnder interferometer including the first optical waveguide and a second optical waveguide. The first optical waveguide includes a first semiconductor junction diode based on the at least one dopant, and the second optical waveguide includes a second semiconductor junction diode based on the at least one dopant.

Some aspects of this disclosure relate to another silicon-photonic optical modulator that includes an optical input; an optical waveguide configured to receive light from the optical input, wherein the optical waveguide is configured as a rib waveguide that includes a rib arranged on a slab, and wherein the rib waveguide has a geometry that is configured to propagate quasi-transverse-magnetic (quasi-TM) polarized light; and an electrode configured to apply an electric field across the rib waveguide. A width of the rib waveguide is in a range from 250 nm to 400 nm.]

Implementations of this and other modulators discussed herein can have one or more of at least the following characteristics.

In some implementations, a height of the rib waveguide is greater than the width of the rib waveguide.

In some implementations, a height of the rib waveguide is within a range of 300 nm to 400 nm, and a thickness of the slab is within a range of 50 nm to 150 nm.

In some implementations, the width of the rib waveguide is in a range from 250 nm to 360 nm.

In some implementations, the optical waveguide is a first rib waveguide, and the silicon-photonic optical modulator includes a second rib waveguide. A gap between the first rib waveguide and the second rib waveguide is less than 500 nm wide.

In some implementations, a height of the first rib waveguide is greater than a height of the second rib waveguide by at least 10 nm in at least part of the silicon-photonic optical modulator.

Some aspects of this disclosure relate to a method of manufacturing a silicon-photonic optical modulator. The method includes forming a rib waveguide on a substrate, the rib waveguide including a rib arranged on a slab; and implanting at least one dopant into the rib. An average concentration of the at least one dopant in a vertical doping profile in a lowermost portion of the rib is larger than an average concentration of the at least one dopant in the vertical doping profile in an uppermost portion of the rib. The uppermost portion of the rib has a height that is between 20% and 80% of a height of the rib waveguide, and the lowermost portion of the rib includes a remainder of the rib below the uppermost portion.

This and other methods discussed herein can have one or more of at least the following characteristics.

In some implementations, implanting the at least one dopant into the rib includes directing a beam of the at least one dopant into the rib in a direction from a side of the substrate on which the rib is disposed, towards the substrate.

In some implementations, the beam has an acceleration energy in a range from 50 keV to 230 keV.

Some aspects of this disclosure relate to a method of modulating quasi-transverse-magnetic (TM) polarized light. The method includes inputting an input quasi-TM polarized light into an optical waveguide, wherein the optical waveguide is configured as a rib waveguide that includes a rib arranged on a slab, wherein the rib includes at least one dopant, wherein an average concentration of the at least one dopant in a vertical doping profile in a lowermost portion of the rib is larger than an average concentration of the at least one dopant in the vertical doping profile in an uppermost portion of the rib, wherein the uppermost portion of the rib has a height that is between 20% and 80% of a height of the rib waveguide, and wherein the lowermost portion of the rib includes a remainder of the rib below the uppermost portion; and applying at least one electric field across the rib waveguide.

The details of one or more implementations of the subject matter of this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example of a top view of a modulator according to some implementations of this disclosure;

FIG. 2 illustrates an example of a cross section of a modulator according to some implementations of this disclosure;

FIG. 3 illustrates an example of an equivalent circuit along a cross-section of a modulator according to some implementations of this disclosure;

FIGS. 4A, 4C, and 4G illustrate examples of detailed cross sections of a single waveguide of a modulator according to some implementations of this disclosure;

FIG. 4B illustrates an example of a vertical doping profile in the waveguide of FIG. 4A, according to some implementations of this disclosure;

FIGS. 4D-4F illustrate examples of a vertical doping profile in the waveguide of FIG. 4C, according to some implementations of this disclosure;

FIG. 4H illustrates examples of vertical doping profile in the waveguide of FIG. 4G, according to some implementations of this disclosure;

FIGS. 5A and 5B illustrate examples of TE and TM modes in silicon rib waveguides, respectively;

FIG. 6 illustrates an example of a top view of a modulator, according to some implementations of this disclosure;

FIG. 7 illustrates another example of a top view of a modulator, according to some implementations of this disclosure;

FIG. 8 illustrates an example of a cross section of a modulator, according to some implementations of this disclosure;

FIG. 9 is a flowchart illustrating an example of modulating quasi-TM polarized light, according to some implementations of this disclosure; and

FIG. 10 is a flowchart illustrating an example of modulating a TM polarized optical signal, according to some implementations of this disclosure; and

FIG. 11 is a flowchart illustrating an example of manufacturing an optical modulator, according to some implementations of this disclosure.

FIG. 12 is a diagram illustrating examples of non-uniform vertical doping profiles.

### DETAILED DESCRIPTION

Systems and techniques are disclosed herein that provide electro-optic modulators in silicon photonics which can achieve a higher bandwidth and/or lower loss as compared with other electro-optical modulators. This is accomplished, in some implementations, by rib waveguides that incorporate non-uniform vertical doping profiles. The non-uniform doping can reduce the electrical resistance associated with switching the modulator, improving switching speeds. In some implementations, the rib waveguides have wide ribs that significantly reduce sidewall-associated loss in transverse-magnetic (TM) polarized light propagating through the waveguides. These and other features described herein can be incorporated into electro-optic modulators having a structure that enables use of TM polarized light in the modulator, instead of transverse-electric (TE) polarized light. In some implementations, this is enabled by a rib waveguide structure in which the waveguide height is greater than the waveguide width. This, in turn, generally results in TM light having a higher effective index than TE light in the rib waveguide, e.g., based on a combination of suitable rib dimension(s) (e.g., rib height and/or width) and slab dimension(s) (e.g., slab thickness).

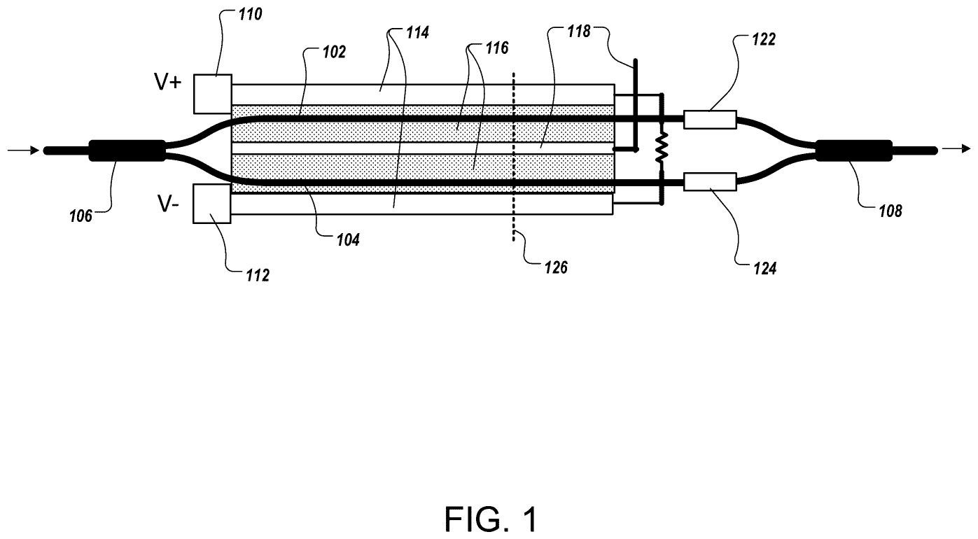

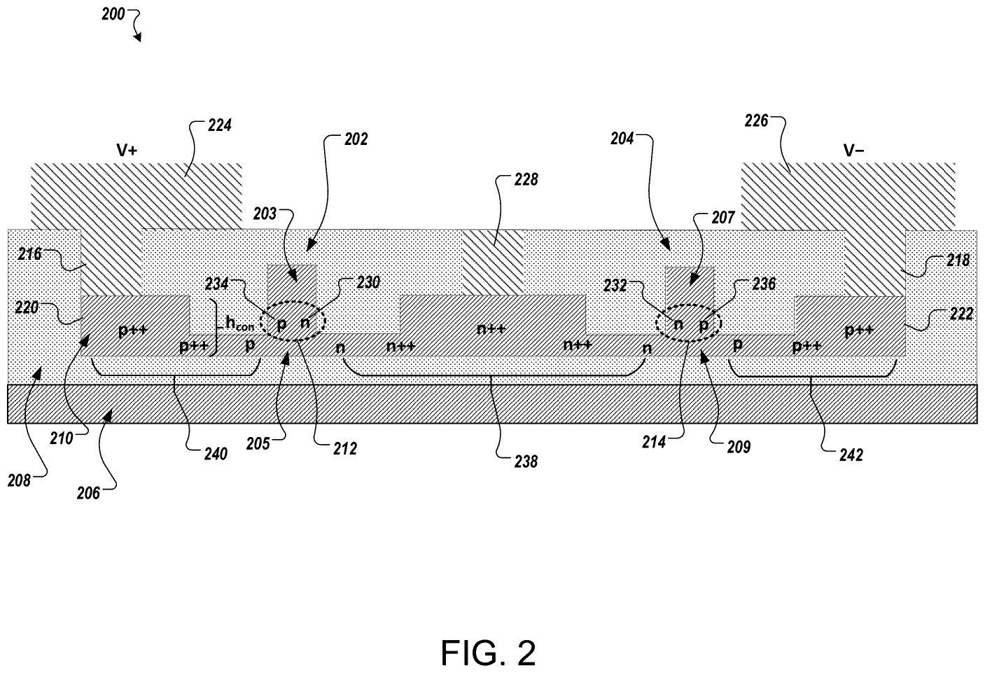

FIG. 1 illustrates an example of a top view of a differential modulator 100 in which implementations of this disclosure may be utilized. In this example, the modulator 100 is based on a Mach-Zehnder interferometer (MZI) implementation, in which optical signals propagate along the length of the modulator 100 (e.g., from left to right in FIG. 1) along two optical transmission paths 102 and 104. At the input of modulator 100, optical splitter 106 splits an input light into the two optical transmission paths 102 and 104. At the output of the modulator 100, the optical combiner 108 combines light output from the two optical transmission paths 102 and 104. The optical splitter 106 and the optical combiner 108 may be implemented in various ways, for example, using symmetric, asymmetric, or tunable optical intensity couplers. The optical transmission paths 102 and 104 can be implemented by waveguides formed in a semiconducting structure 116, as described in further detail with reference to FIG. 2, below. In some implementations, the optical cores of the waveguides, and/or the optical splitter 106, and/or the optical combiner 108 can include silicon ribs. For example, the transmission paths 102 and 104 can include rib waveguides such as waveguide 420 and/or waveguide 450. In some implementations, an optical phase rotator may be implemented between the input of modulator 100 and the optical transmission paths 102 and 104, which rotates a phase of the input light so that quasi-TM light propagates in the optical transmission paths 102 and 104.

The modulator 100 uses a travelling wave configuration in which voltages applied at terminals 110 and 112 create an electrical signal that propagates along a radio frequency (RF) transmission line 114, which is terminated at an RF termination resistance. The electrical signal in RF transmission line 114 travels at the same speed as and induces electro-optic modulation in the light that propagates along the two optical transmission paths 102 and 104. In particular, the RF transmission line 114 is connected to the semiconducting structure 116 via electrodes (described in further detail with reference to FIG. 2, below) that apply respective voltages, and resulting electric fields, across one or both of the optical transmission paths 102 and 104. The applied voltage(s) induce a phase shift in the light that propagates in one or both of the optical transmission paths 102 and 104. In some implementations, the phase shift is differential in that the phase shift magnitude is equal and the phase shift sign is opposite between the optical transmission paths 102 and 104.

Electro-optic modulation is achieved by varying the voltage at one or both of the terminals 110 and 112 to modulate the differential phase shift between the phase of light in the first optical transmission path 102 and the phase of light in the second optical transmission path 104. For example, if the terminal voltages are controlled such that the differential phase shift causes destructive interference at the optical combiner 108, then this corresponds to an “off” or logic “0” state of the modulator 100. By contrast, if the terminal voltages are controlled such that the differential phase shift between the two optical transmission paths 102 and 104 causes constructive interference at the optical combiner 108, then this corresponds to the “on” or logic “1” state of the modulator 100.

The differential phase shift between the two optical transmission paths 102 and 104 can also be influenced by other factors. For example, the physical lengths of the optical transmission paths 102 and 104 can be the same to provide zero inherent differential phase shift or can be different lengths to provide non-zero inherent differential phase shift. Furthermore, in some implementations, direct current (DC) phase shifters 122 and 124 (e.g., thermo-optic phase-shifters, such as optical waveguide heaters) may be implemented near the ends of the optical transmission paths 102 and 104 to control the relative phases of the two light signals before combination in the optical combiner 108.

In some implementations, the phase modulation can be performed by a “push-pull” mechanism, in which the phases of light in both of the optical transmission paths 102 and 104 are modulated, to control the relative phase shift between the two paths. In push-pull operation, the voltage V+ at terminal 110 is increased and voltage V− at terminal 112 is decreased (or vice versa), resulting in corresponding phase shifts of light in each of the optical transmission paths 102 and 104. Push-pull modulation can provide various advantages over non-push-pull modulation, such as achieving smaller average energy consumption and reduced chirp in the modulated signal.

In some scenarios, a direct current (DC) bias connection 118 can be connected between the two optical transmission paths 102 and 104. The DC bias connection 118 is implemented such that semiconductor junction diodes in each of the optical transmission paths 102 and 104 remain reverse biased, even when data signals applied at the terminals 110 and 112 vary between logical 1 and logical 0. Further details are provided with reference to FIG. 2, below.

FIG. 2 illustrates an example of a cross section of a modulator 200 (e.g., cross section 126 of the modulator 100 of FIG. 1).

The cross-section of modulator 200 shows details of the MZI structure. The MZI includes a first optical waveguide 202 and a second optical waveguide 204. In some implementations, the modulator 200 includes a substrate 206 (e.g., a silicon substrate), an insulating structure/layer 208 (e.g., a dielectric, such as an oxide), and a semiconducting structure 210 (e.g., a silicon layer which includes optical waveguides 202 and 204).

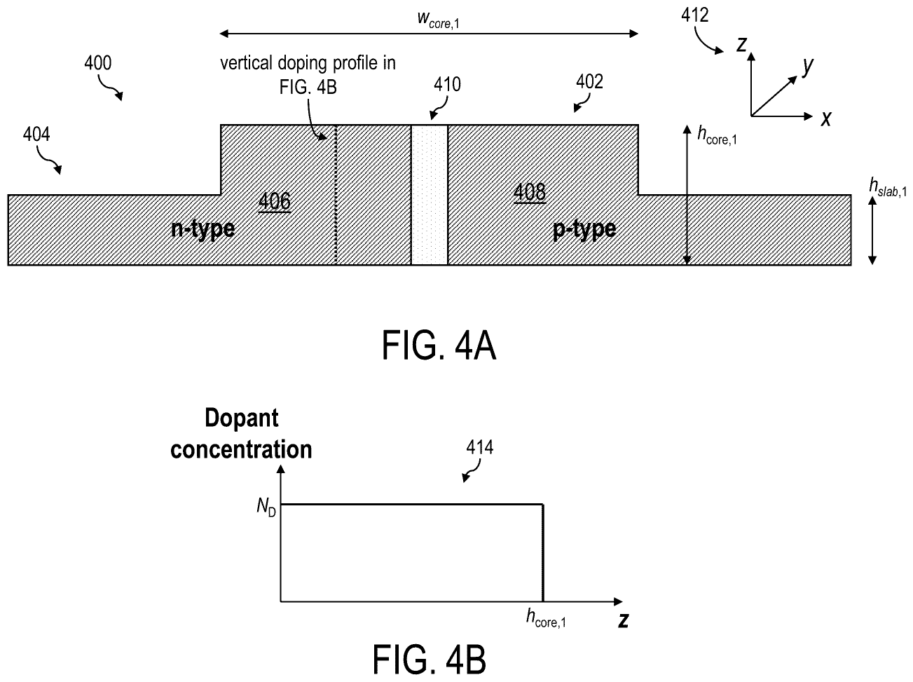

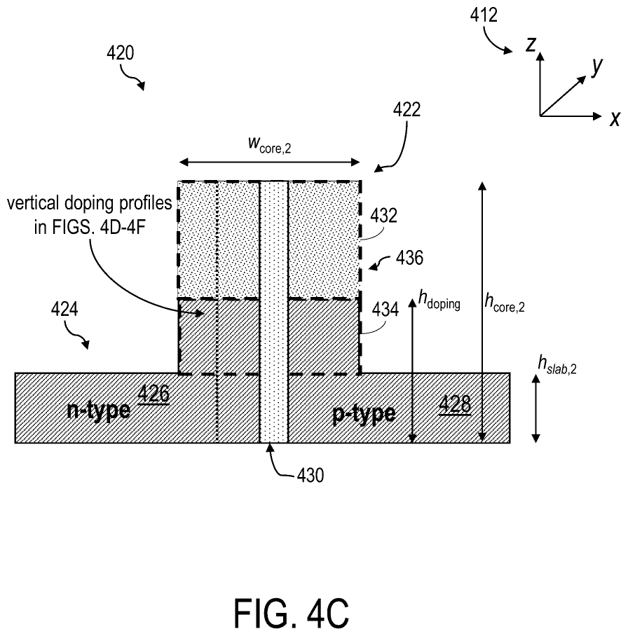

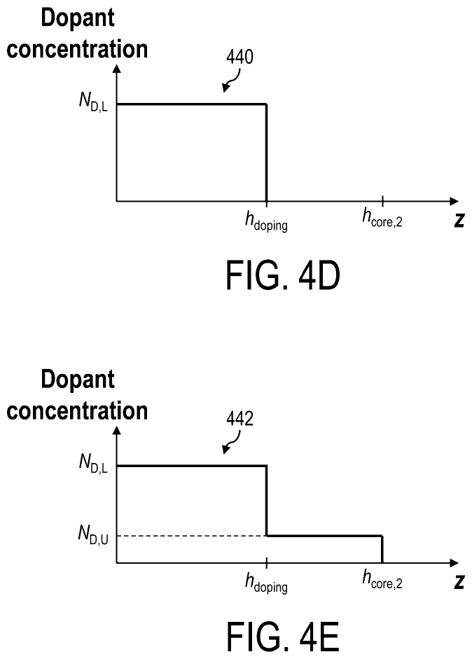

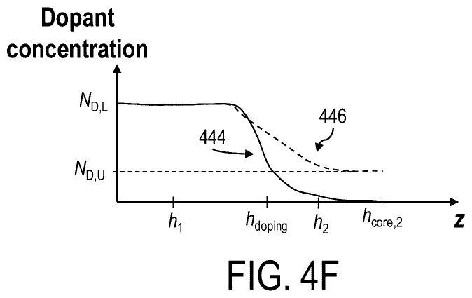

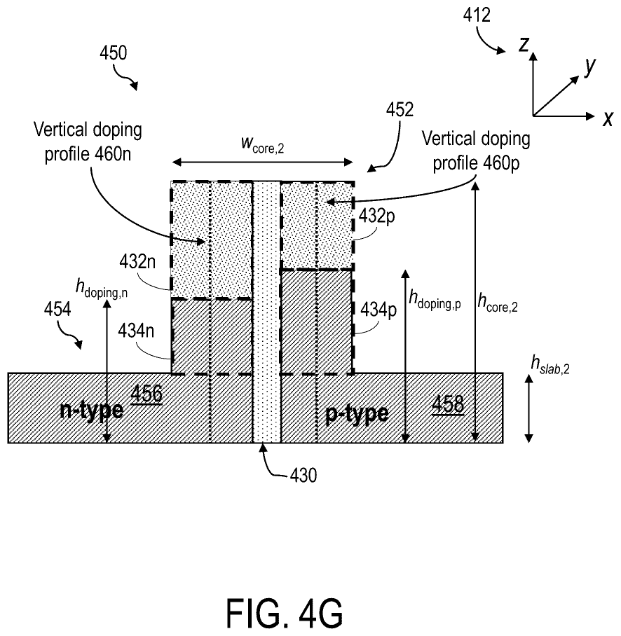

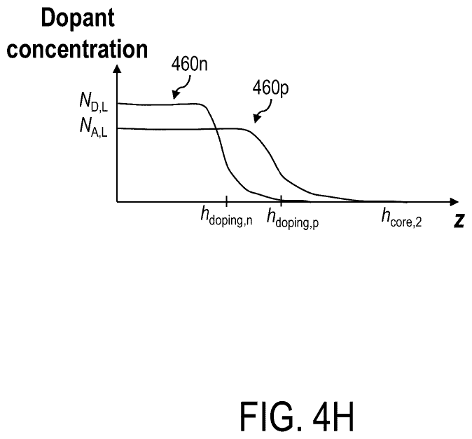

The optical waveguides 202 and 204 can be implemented, for example, as silicon ribbed waveguides on top of a slab. In the example of FIG. 2, optical waveguide 202 includes a rib 203 which is arranged on top of a slab 205. Similarly, optical waveguide 204 includes a rib 207 on top of a slab 209. The ribs 203, 207 and the slabs 205, 209 are all parts of the semiconducting structure 210. Further details of the ribbed waveguide structure are discussed with reference to FIGS. 4A-4H, below.

Each of the optical waveguides 202 and 204 includes a semiconductor junction. The semiconductor junction diodes can be implemented, for example, by a PIN (p-type/intrinsic/n-type) junction diode or a p/n junction diode. In modulator 200, a p/n junction is implanted into each of the optical waveguides 202 and 204, forming a diode in each waveguide. These diodes are shown as first semiconductor junction diode 212 and second semiconductor junction diode 214. As discussed with respect to FIGS. 4A-4H, in some implementations, vertical doping profiles in the ribs 203, 207 are non-uniform.

The modulator 200 also includes electrodes 216 and 218 (e.g., metal electrodes) which are in physical contact with the semiconducting structure 210. In some implementations, the electrodes 216 and 218 are in physical contact with p-doped contact regions 220 and 222 of the semiconducting structure 210. The electrodes 216 and 218 may be formed, for example, by etching the insulating layer 208 and forming metal (e.g., tungsten, copper, and/or aluminum) contacts. In some implementations, the p-doped regions may instead be n-doped regions, and vice-versa, in modulator 200 (e.g., so that contact regions 220 and 222 are N-doped instead P-doped).

In some implementations, one or both electrodes 216, 218 are in contact with a portion of semiconductor material (such as silicon) having a thickness greater than the slab thickness (e.g., h_{slab,1} or h_{slab,2} discussed below), e.g., are in contact with a protruding portion of the semiconductor material. For example, a vertical height h_{con} of one or both contact regions 220, 222 (shown in FIG. 2) can be larger than the slab thickness. This can provide a more robust electrical contact than contacting the slab directly or contacting a portion of semiconductor material having the same thickness as the slab. In various implementations, h_{con} can be greater than, less than, or equal to h_{core}, the rib height. In some cases, having h_{con} be equal to h_{core} can facilitate simplified manufacturing, e.g., because the contact region and the rib can be defined in a common fabrication step. The foregoing description of the contact regions 220, 222 can also apply to other contact regions discussed herein, such as contact regions, 820, 822.

The modulator 200 may also include metal layers 224 and 226 on top of the electrodes 216 and 218. In some implementations, the metal layers 224 and 226 may form segments of an RF transmission line (e.g., RF transmission line 114 in FIG. 1).

In some scenarios, a DC bias connection 228 is implemented between the two optical waveguides 202 and 204. The DC bias connection 228 ensures that the semiconductor junction diodes 212 and 214 remain reverse biased during modulation. For example, in a push-pull mode of modulation, a differential voltage (e.g., V+ and V−) is applied at the metal layers 224 and 226 (and hence at electrodes 216 and 218). If the voltage (e.g., V+) at first electrode 216 is increased while the voltage (e.g., V−) at the second electrode 218 is decreased, then a width of the depletion region in the first optical waveguide 202 decreases while a width of the depletion region in the second optical waveguide 204 increases (and vice versa). As the depletion widths change, this changes the effective refractive index experienced by the light traveling along each of the optical waveguides 202 and 204, resulting in corresponding phase shifts of the light. As a result, push-pull modulation can be achieved in the modulator 200.

In the example of modulator 200, the DC bias connection 228 is applied at the cathodes 230 and 232 (N-doped regions) of the semiconductor junction diodes 212 and 214, while the varying voltages V+ and V− are applied at the anodes 234 and 236 (P-doped regions) of the semiconductor junction diodes 212 and 214. The DC bias connection 228 ensures that the semiconductor junction diodes 212 and 214 remain reverse biased. For example, in the example of modulator 200, if the bias voltage applied at the DC bias connection 228 is very low (or non-existent), then this may result in activation of the first semiconductor junction diode 212 (e.g., forward bias above approximately 0.6 V for silicon) with a significant number of carriers injected into the depletion region of the first semiconductor junction diode 212, resulting in forward bias and slower operation. Implementing the DC bias connection 228 with a sufficiently large bias voltage ensures that the semiconductor junction diodes 212 and 214 remain reverse biased under modulation.

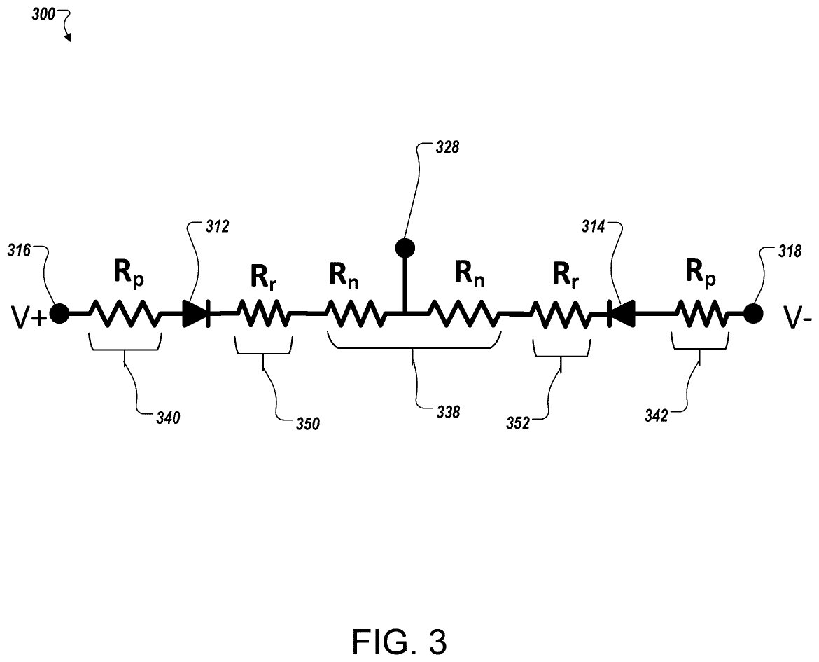

FIG. 3 illustrates an example equivalent circuit 300 along a cross-section of a modulator (e.g., the cross section 126 of the modulator 100 of FIG. 1).

In the example of FIG. 3, the electrical series resistance 340 between first electrode 316 and first semiconductor junction diode 312 (e.g., corresponding to semiconducting region 240 in FIG. 2) is denoted Rₚ (e.g., in units of mΩ-m). The electrical series resistance 342 between second electrode 318 and second semiconductor junction diode 314 (e.g., corresponding to semiconducting region 242 in FIG. 2) is also denoted Rₚ (although the actual values of electrical series resistances 340 and 342 may be different, in some implementations). The electrical series resistance 338 between semiconductor junction diodes 312 and 314 (e.g., corresponding to semiconducting region 238 in FIG. 2) is 2*Rₙ (with Rₙ series resistance between each of semiconductor junction diodes 312 and 314 and DC bias voltage connection 328).

In the equivalent circuit for the phase modulator shown in FIG. 3, the resistances Rₙ and Rₚ originate primarily from the slab and can limit the modulator bandwidth. Increasing the doping in the slab reduces the resistance, thus increasing the bandwidth, but it also increases the optical loss, because doped silicon is absorptive.

In addition, each semiconductor junction diode 312, 314 has an associated series resistance Rᵣ (sometimes referred to as a rib resistance) corresponding to charge transport through the ribs 203, 207 between the cathodes 230 and 232 and the anodes 234 and 236, e.g., laterally between n-doped and p-doped sides of each rib 203, 207 above the slab. For purposes of this disclosure, it has been recognized that this rib resistance can also be an important or primary limiter of modulator bandwidth, instead of or in addition to the resistances Rₙ and Rₚ associated with the slab. It has been further recognized that upper portions of the ribs 203, 207 may contribute relatively little to phase modulation based on depletion region adjustment compared to lower portions of the ribs 203, 207. As such, some implementations according to this disclosure feature vertically non-uniform n-doping and/or p-doping in one or more waveguide ribs (e.g., with higher doping levels in lower portions of the ribs and less or no doping in higher portions of the ribs), reducing the rib capacitance C and, as a result, the product RᵣC² and/or RᵣC and providing higher-bandwidth modulators. Further details on vertically non-uniform doping are provided with respect to FIGS. 4A-4H.

FIG. 4A illustrates, in cross-section, an example of a single waveguide of a silicon-photonic depletion phase modulator (e.g., a waveguide in one of transmission paths 102 or 104 of modulator 100, or one of waveguides 202 or 204 in FIG. 2). In particular, FIG. 4A illustrates an example of a waveguide 400 configured for TE-polarized light and having uniform vertical doping profiles. Waveguide 400 is implemented by a rib waveguide structure, with a rib 402 on top of a slab 404. Light is guided along the rib 402 and propagates in a longitudinal direction y of the modulator (normal to the x-z cross section shown in FIG. 4A, as indicated by coordinate system 412) by total internal reflection inside the rib 402. The rib 402 extends from the slab 404 in a vertical direction z. For example, the vertical direction z can be orthogonal to a surface of a substrate on which the waveguide 400 is formed, such as substrate 206. A lateral direction x is orthogonal to the vertical direction z and the longitudinal direction y and can define a direction across the rib 402 and parallel to an electric field generated in a p/n junction in the rib 402.

The waveguide 400 includes an n-type region 406 in one lateral side of the slab 404 and the rib 402 and a p-type region 408 in an opposite lateral side of the slab 404 and the rib 402, the regions 406, 408 forming a semiconductor junction diode. An intermediate region 410 can be a depletion region formed spontaneously between the n-type and p-type regions 406, 408 (e.g., in a case in which the n-type and p-type regions 406, 408 directly abut one another laterally to form a p/n diode), and/or can include an intrinsic, undoped region in a case in which the regions 406, 408, 410 form a PIN diode.

The rib structure allows for a confined optical mode in the rib 402 while enabling electrical connections to the rib 402 through the regions on both sides of the slab 404. As discussed with reference to FIG. 2 above, phase modulation of light in the rib 402 is achieved by modulating the voltage difference between the n-doped and p-doped regions 406, 408 of the waveguide 400. For example, increasing the voltage difference between the n-doped and p-doped regions 406, 408 widens the width of a depletion region in the intermediate region 410, thereby increasing the effective refractive index of the optical mode and allowing for phase modulation of the light in the rib 402.

The waveguide 400 differs from some other waveguides discussed herein in several aspects. First, the waveguide 400 is configured for propagation of TE-polarized light based on the dimensions of the waveguide 400. As shown in FIG. 4A, the slab thickness is h_{slab,1}. The rib 402 has a rib height h_{core,1} and a rib width w_{core,1} and, in some implementations, to configure the waveguide 400 for propagation of TE-polarized light, the rib height h_{core,1} is less than the rib width w_{core,1}, e.g., the waveguide 400 has a generally wide and short shape. This causes the effective index of the TE 2D waveguide mode in the rib 402 to be higher than the effective index of the TM 1D slab mode, ensuring that a guided TE mode will suffer less leakage to the slab 404 than a guided TM mode.

There are various reasons why silicon-photonic modulators and waveguides, such as waveguide 400, are often configured for TE-polarized light.

First, for modulators that employ rib waveguides, the TM 2-D rib mode index is typically significantly lower than the TE 1-D slab mode index. The rib waveguides need special conditions to guide TM light, conditions which are not normally met. For example, in some cases, TM light is guided when the effective index of the TM 2-D rib mode is larger than that of the TE 1-D slab mode. The “slab mode” refers to a 1-D mode that would be guided if there were no rib 402, and if the slab 404 were infinitely wide. When this effective index condition is not met, the TM rib mode will be phase matched to the TE slab mode propagating at certain angles with respect to the rib 402. In such a case, small perturbations will cause the light in the TM mode to leak away into the slab 404.

Second, TE-polarized light has a tighter vertical confinement in the rib 402, as compared to TM-polarized light, which mitigates losses due to the substrate below and layers on top. For example, in some implementations, there are metal routing layers above the silicon, and the metal layers can be significantly closer to the silicon before causing significant optical losses for TE-polarized light than TM-polarized light.

Third, in most silicon photonic modulators, the waveguide height h_{core,1} is less than the waveguide width w_{core,1}, which results in TE-polarized light having a higher effective index than TM-polarized light. This allows for a smaller bend radius, decreasing the size of the silicon photonic devices.

Fourth, most silicon-photonic modulators employ TE-polarized light because most of the other elements in a silicon photonic circuit are designed for TE polarization. For example, most grating couplers are configured for TE polarization.

Fifth, in many scenarios, it is typically easier to fabricate a waveguide structure that has a width greater than its height (correspond to TE transmission), e.g., because the lithography process is simplified by a shallower depth of etching.

However, in some cases, the use of TM polarized light can provide distinct advantages. For example, TM-polarized light has the advantage of having less light in the slab, as compared to TE-polarized light. To understand why TM-polarized light has less light in the slab than TE-polarized light, one can consider the boundary conditions on the electric field of light that are given by Maxwell's equations. In non-magnetic materials, such as silicon, the transverse electric field, E_{∥}, is continuous across a boundary, whereas the normal electric field times the permittivity, (E_{⊥}) (ε), is continuous across a boundary. Because the permittivity of silicon is approximately 5.8 times than that of oxide, when the electric field is normal to a thin piece of silicon surrounded by oxide, the electric field inside that silicon is approximately 5.8 times lower than in the surrounding oxide. Thus, TM-polarized light has very little electric field inside the silicon slab.

In practical implementations, the guided optical mode is typically a quasi-TE or quasi-TM mode, because guided 2D modes are almost never purely TE or TM modes. In a quasi-TM mode, the dominant component of the electric field of the light is aligned along the z-axis. In a quasi-TE mode, the dominant component of the electric field of the light is aligned along the x-axis. For the sake of brevity in exposition, the word “quasi” may be omitted when discussing the polarization of a guided optical mode in this disclosure.

Another difference between the waveguide 400 and some other waveguides discussed herein relates to vertical doping profiles. The waveguide 400 has vertically-uniform n-type and p-type doping profiles. As shown in FIG. 4B, for a vertical doping profile (profile along the z direction) in the n-type region 406, the dopant concentration N_{D} 414 is substantially constant through an entire depth of the waveguide 400, e.g., through the rib 402 and the underlying slab 404 from a height z=0 (at the base of the slab 404) to a height h_{core,1} at the top of the rib 402. Another uniform vertical doping profile (not shown) applies in the p-type region 408, with a constant dopant concentration N_{A}. As discussed in further detail below, (e.g., with respect to FIGS. 4C-4H) some waveguides within the scope of this disclosure can have non-uniform vertical doping profiles.

FIG. 4C illustrates a cross-section of a waveguide 420 configured to transmit TM-polarized light. The waveguide 420 has a rib 422 on top of a slab 424, as described in reference to FIG. 4A. In addition, as described in reference to FIG. 4A, an n-type region 426 and a p-type region 428 are arranged in the slab 424 and in the rib 422 on opposite lateral sides. The waveguide 420 has a rib width w_{core,2}, a rib height h_{core,2}, and a slab thickness h_{slab,2}. A depletion region 430 (in some implementations included in an undoped region of a lateral PIN junction) forms between the n-type and p-type regions 426, 428. Elements of the waveguide 420 can have the same characteristics described for those elements in waveguide 400, except where indicated otherwise.

In some implementations, to configure the waveguide 420 for transmission of TM-polarized light, the waveguide 420 has generally narrow and tall dimensions compared to the wide and short dimensions of the waveguide 400. The narrower and taller configuration of waveguide 420 in FIG. 4C can, among other benefits, enable a reduction in the portion of the optical mode that is in the slab 424, allowing for a higher doping in the slab 424 for the same optical loss, as compared to waveguide 400 of FIG. 4A. The higher doping in the slab 424, in turn, allows for a higher bandwidth in a modulator using waveguide 420, as compared with a modulator using waveguide 400, without having to increase the optical loss, based on the use of TM polarized light in the modulator using waveguide 420 instead of TE polarized light.

For example, in some implementations, the rib height h_{core,2} is greater than a threshold of approximately 0.85λ/n, and the rib width h_{core,2} is larger than the slab thickness h_{slab,2}, where λ is the free-space wavelength of light and n is the refractive index of silicon. This guarantees that, for TM-polarized light, the electric field falls to a low value at the top and bottom of the waveguide so that the electric field boundary condition (discussed above) does not cause significant field strength to fall outside the waveguide. For instance, for a wavelength of λ=1310 nm, the threshold is 0.85λ/n=320 nm. Thus, in this example, the waveguide rib height h_{core,2} should be larger than 320 nm and the waveguide rib width h_{core,2} should be larger than 90 nm. In some implementations, TM transmission is efficient when h_{core,2}>w_{core,2}. For example, an effective refractive index of a TM polarization two-dimensional (2D) guided mode in the rib waveguide can be greater than at least one, or all, effective refractive indexes of transverse-electric (TE) polarization one-dimensional (1D) guided modes in the slab.

As comparative examples of waveguide dimensions, in a case where the slab thickness h_{slab,1}=h_{slab,2}=90 nm, the waveguide 400 can have a waveguide rib height h_{core,1} and a rib width w_{core,1} of 220 nm and 420 nm, respectively, whereas the waveguide 420 can have a waveguide rib height h_{core,2} and a rib width w_{core,2} of 400 nm and 220 nm, respectively.

Although the aforementioned conditions of h_{core,2}>0.85λ/n, h_{core,2}>h_{slab,2}, and/or h_{core,2}>w_{core,2}, can enable preferential transmission of TM-polarized light, for purposes of this disclosure, it has been further recognized that TM modes are sensitive to roughness at sidewalls of the rib (e.g., at sidewall 436). Roughness at the rib sidewall induces loss in TM light transmitted down the waveguide, and, due to the tight confinement of TM modes, this loss may be higher than sidewall loss for TE light in waveguides configured for TE transmission. However, it has been found that the sidewall loss is unexpectedly sensitive to rib width, e.g., the sidewall loss decreases significantly with even small increases in w_{core,2} within a certain range of w_{core,2}. For example, in some implementations, a rib width 250 nm<w_{core,2}<400 nm or 300 nm<w_{core,2}<400 nm or 250 nm<w_{core,2}<360 nm or 300 nm<w_{core,2}<360 nm has been found to provide an effective tradeoff between low-loss TM transmission and modulation efficiency (e.g., because the depletion region 430 between the n-type region 426 and the p-type region 428 is proportionally less of the width w_{core,2} of the rib 422 as the width w_{core,2} is increased), e.g., for 1310 nm light. This rib width can provide benefits even in waveguides that do not incorporate non-uniform vertical doping profiles; as such, some implementations according to this disclosure have a rib width 250 nm<w_{core,2}<400 nm and have uniform vertical doping profiles.

Moreover, it has been further found that, in some implementations, one or more of the aforementioned conditions can be relaxed while retaining acceptable device performance (e.g., TM-polarized light transmission), permitting greater design flexibility and, in some cases, improved values of other parameter(s), based on the relaxation of the condition(s). For example, it has been found that, in some implementations, h_{core,2}>0.80λ/n, h_{core,2}>h_{slab,2}, and/or h_{core,2}>0.9 w_{core,2} can provide effective transmission and modulation performance. In some implementations, one or more of these conditions are provided alongside a rib width 250 nm<w_{core,2}<400 nm.

However, other rib widths are also within the scope of this disclosure. For example, in some implementations the rib width is less than 250 nm or less than 300 nm, e.g., in a range from 150 nm to 250 nm. In some implementations, the rib height is in a range from 300 nm to 400 nm. In some implementations, the slab thickness is in a range from 50 nm to 150 nm.

Referring again to FIG. 4C, in some implementations, the waveguide 420 has a non-uniform vertical doping profile in the rib 422. For example, the waveguide 420 can have a “deep” doping profile in which vertically-lower portions of the rib 422 (closer to the slab 424 along the z axis) have higher dopant concentrations (of donors in the n-type region 426, acceptors in the p-type region 428, or both) than vertically-higher portions of the rib 422. As such, the product of the rib resistance associated with lateral transport in the rib 422 (Rᵣ, discussed with respect to FIG. 3) with the square of the rib capacitance C can be reduced, compared to cases in which the rib 422 is uniformly doped.

RᵣC² is a relevant quantity for consideration because the power dissipated is I²Rᵣ, where I is the current, and I is approximately proportional to C in typical regimes for waveguide modulators. Accordingly, a decreasing value of RᵣC² corresponds to a decreased amount of RF power lost in the rib resistance Rᵣ. In some implementations, the product RᵣC is reduced based on the vertically non-uniform doping, which may correspond to decreased switching times and faster modulation.

The reduced RᵣC² product can correspond to decreased capacitance per unit length (length in the y direction) and/or decreased loss per unit length. The decreased capacitance can be based at least on the reduction of the area of the semiconductor junction diode formed by n-type and p-type regions 426, 428: the diode can be modeled as a parallel-plate capacitor, and the undoped or less-doped upper portion of the rib 422 contributes less or not at all to the area (in the y-z plane) of the parallel plate capacitor. In addition, lower doping levels correspond to increased depletion region widths (e.g., width of the depletion region 430 at higher, less doped portions of the rib 422) and, correspondingly, lower diode capacitances in the rib 422. Accordingly, based on some implementations of the non-uniform doping discussed herein, an increase in Rᵣ based on vertically-non-uniform doping can be counterbalanced by a decrease in the capacitance C, such that RᵣC² and/or RᵣC decreases compared to the case of uniform doping.

The decreased loss per unit length is a result of the lower doping levels, as higher-doped silicon is more absorptive than less-doped silicon. Accordingly, light transmitted through the rib 422, including through the less-doped vertically-higher portions of the rib 422, may experience less attenuation than if the doping were vertically-uniform.

Because of the reduced doping level at higher portions of the rib 422, phase modulation by depletion width adjustment may be somewhat less effective than in modulators with vertically-uniform high levels of doping. For example, V_{π}L may be increased compared to the case of uniform high doping. However, in some implementations, the benefits to conductance, capacitance, and optical loss per unit length outweigh this possible reduction in modulation efficiency.

Referring again to FIG. 4C, the rib 422 can be conceptually divided into an upper portion 432 and a lower portion 434, and, for one or both doped lateral sides of the rib 422, an average doping concentration in the lower portion 434 along a vertical doping profile is higher than in the upper portion 432. The edge between the lower portion 434 and the upper portion 432 is defined at a vertical height h_{doping} relative to a base of the slab 424. This “deep doping” profile can take a variety of forms in different implementations.

For example, FIGS. 4D-4F illustrate examples of doping concentration (e.g., in cm⁻³) as a function of height along a vertical doping profile in the n-doped lateral side of the rib 422, where z=0 is defined at the base of the slab 424. In some implementations, as shown for vertical doping profile 440 in FIG. 4D, the lower portion 434 has a substantially constant doping concentration N_{D,L}, and the upper portion 432 is substantially undoped. In some implementations, as shown for vertical doping profile 442 in FIG. 4E, the lower portion 434 has a substantially constant doping concentration N_{D,L}, and the upper portion 432 has a substantially constant doping concentration N_{D,U}, where N_{D,L}>N_{D,U}. For example, in some implementations, N_{D,L} is at least 1.5 times N_{D,U} or at least twice N_{D,U}, differences in doping that have been found to provide the aforementioned benefits associated with rib resistance reduction while retaining an acceptable modulation efficiency.

FIG. 4F illustrates examples of doping profiles that may be practically obtained, for example, by implanting dopant ions into the rib 422 from above (downward in the z direction). Rather than an abrupt, exact drop in dopant concentration exactly at z=h_{doping}, there is an at least somewhat gradual decrease in dopant concentration from its value N_{D,L} in the lower portion 434, converging to either zero (for profile 444) or N_{D,H} (for profile 446) in the upper portion 432. Accordingly, the condition that N_{D,L} is at least 1.5 times N_{D,U} or at least twice N_{D,U} can be expressed instead as an average concentration in the lower portion 434 along a vertical doping profile being at least 1.5 times an average concentration in the upper portion 432 along the vertical doping profile or at least twice an average concentration in the upper portion 434 along the vertical doping profile.

Relative heights and thicknesses of the upper portion 432 and the lower portion 434 can vary in different implementations. In some implementations h_{doping}/h_{core,2} is between 0.2 and 0.8, between 0.2 and 0.65, or between 0.35 and 0.65, values that, in conjunction with the average-dopant-concentration conditions discussed above, have been found to provide a useful tradeoff between reduced rib resistance and high modulation efficiency. For example, in some implementations, a lower 0.2 to 0.65 portion of the waveguide 420 has at least 1.5 times or at least twice an average dopant concentration of the remaining upper portion of the waveguide (e.g., upper 0.35 to 0.8 portion of the waveguide 420), along a vertical doping profile.

In some implementations, as shown in the example of FIG. 4C, the upper portion 432 is an uppermost portion of the rib 422, and the lower portion 434 is a remainder of the rib 422, e.g., a lowermost portion of the rib 422 extending from the height z=h_{doping} to the slab 424.

“A concentration of the at least one dopant in a vertical doping profile in the rib is higher in a lower portion of the rib than in an upper portion of the rib” need not rely on a division of the rib into finite-height upper and lower portions such as portions 432, 434 or on a determination of average dopant levels over a finite height. For example, in profile 444, the dopant concentration is greater at z=h₁ than at z=h₂, satisfying the condition that the concentration of the at least one dopant in a vertical doping profile in the rib 422 is higher in a lower portion of the rib 422 than in an upper portion of the rib 422.

Although FIGS. 4D-4F illustrate donor doping profiles in the n-type region 426, the same description can apply for acceptor doping profiles in the p-type region 428. For example, non-uniform vertical doping profiles can exist independently for each of p-type and n-type doping, such that a donor concentration is higher in a lower portion of a first lateral side of the rib 422 than in an upper portion of the first lateral side of the rib 422, and an acceptor concentration is higher in a lower portion of a second, opposite lateral side of the rib 422 than in an upper portion of the second lateral side of the rib 422. The donor and acceptor concentrations in the upper and lower portions need not be (though can be) equal, and the portions of the rib 422 corresponding to the upper and lower portions need not be (though can be) the same for the two doping profiles.

For example, FIG. 4G illustrates an example of a waveguide 450 in which respective upper and lower portions of the rib are defined differently for n-type and p-type doping. The waveguide 450 has a rib 452 on top of a slab 454, as described in reference to FIGS. 4A and 4C. In addition, as described in reference to FIGS. 4A and 4C, an n-type region 456 and a p-type region 458 are arranged in the slab 454 and in the rib 452 on opposite lateral sides. The waveguide 450 has a rib width w_{core,2}, a rib height h_{core,2}, and a slab thickness h_{slab,2}. Elements of the waveguide 450 can have the same characteristics described for those elements in waveguide 420, except where indicated otherwise.

In this example, n-type doping is concentrated in a first lower portion 434n of the rib 452; a first upper portion 432n of the rib 452 is substantially undoped. In addition, p-type doping is concentrated in a second lower portion 434p of the rib 452, and a second upper portion 432p of the rib 452 is substantially undoped. Donor and acceptor doping profiles 460n and 460p, respectively, are shown in FIG. 4H, illustrating that donor and acceptor concentrations N_{D,L} and N_{A,L} in the lower portions 434n, 434p need not be (though can be) equal. As shown in FIG. 4H, the donor dopant concentration transitions to substantially zero at a height h_{doping,n}, and acceptor dopant concentration transitions to substantially zero at a height h_{doping,p}, where h_{doping,n} and h_{doping,p} need not be (though can be equal). The description provided with respect to FIGS. 4C-4F for the vertical doping profile in the n-type region 426 (e.g., relative concentrations at different heights, regions corresponding to the upper/lower portions, etc.) can apply independently for each of the vertical doping profiles 460n, 460p. For example, for each of the n-type and p-type sides independently, a lower 0.2 to 0.65 portion of the waveguide 450 along a vertical doping profile can have at least 1.5 times or at least twice an average dopant concentration of the remaining upper portion of the waveguide (e.g., upper 0.35 to 0.8 portion of the waveguide 420) along the vertical doping profile.

Although the example of FIGS. 4G-4H includes dopant concentrations that drop to zero at upper portions of the rib 452, in some implementations, either or both of the donor dopant concentration or the acceptor dopant concentration can be non-zero at the upper portion of the rib 452, e.g., as described with respect to FIGS. 4E-4F. For example, the upper portions 432n and 432p need not be undoped.

As examples of dopant concentrations, in some implementations, in the p-doped portion of a rib (e.g., boron-doped), the average concentration of the p-type dopant in the lowermost portion of the rib is between 10¹⁷ cm⁻³ and 10¹⁸ cm⁻³, and the average concentration of the p-type dopant in the uppermost portion is less than 10¹⁷ cm⁻³, less than less than 5×10¹⁶ cm⁻³, 10¹⁶ cm⁻³, or less than 5×10¹⁵ cm⁻³, e.g., where the uppermost portion can have a height that is between 20% and 80% or between 35% and 65% of a height of the waveguide. In some implementations, in the n-doped portion (e.g., phosphorus-doped), the average concentration of the n-type dopant in the lowermost portion is between 10¹⁷ cm⁻³ and 10¹⁸ cm⁻³, and the average concentration of the n-type dopant in the uppermost portion is less than 10¹⁷ cm⁻³, less than less than 5×10¹⁶ cm⁻³, 10¹⁶ cm⁻³, or less than 5×10¹⁵ cm⁻³. In some implementations, these ranges of values have been found to provide efficient light transmission, high modulation efficiency, and fast modulation switching.

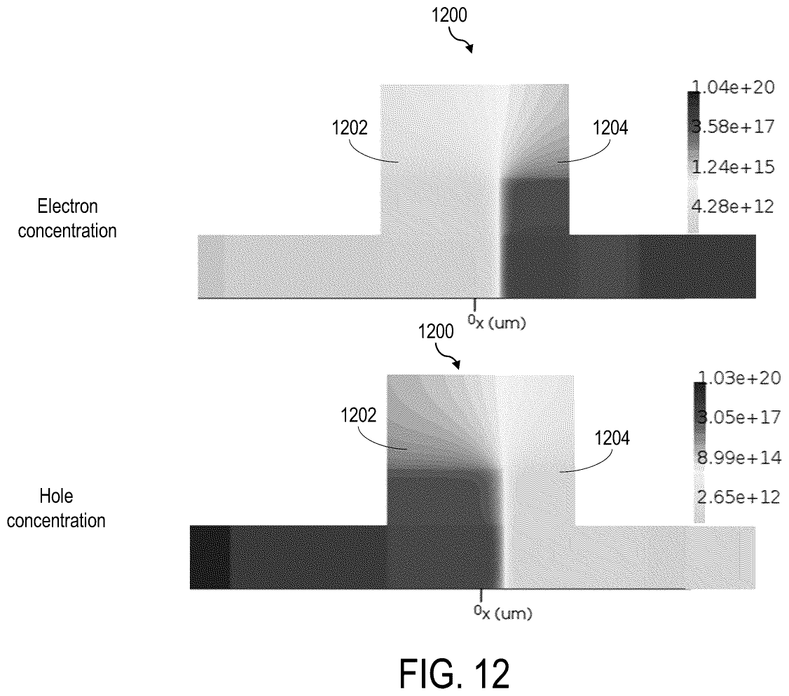

FIG. 12 shows non-limiting examples of electron and hole concentrations in a non-uniformly-doped waveguide rib 1200, as discussed herein. On a p-doped side 1202 of the rib 1200, the hole concentration decreases from about 3×10¹⁷ cm⁻³ at the base of the rib 1200 to about 1×10¹⁵ cm⁻³ at the top of the rib 1200 as a result of vertically non-uniform acceptor doping. On an n-doped side 1204 of the rib 1200, the electron concentration decreases from about 3.5×10¹⁷ cm⁻³ at the base of the rib 1200 to about 1×10¹⁵ cm⁻³ at the top of the rib 1200 as a result of vertically non-uniform donor doping.

Although the foregoing description refers to doping profiles and dopant concentrations (e.g., concentrations of dopant atoms, such as phosphorous or boron), in some implementations the same description can instead or additionally refer to activated dopant concentration, e.g., after an activating high-temperature anneal.

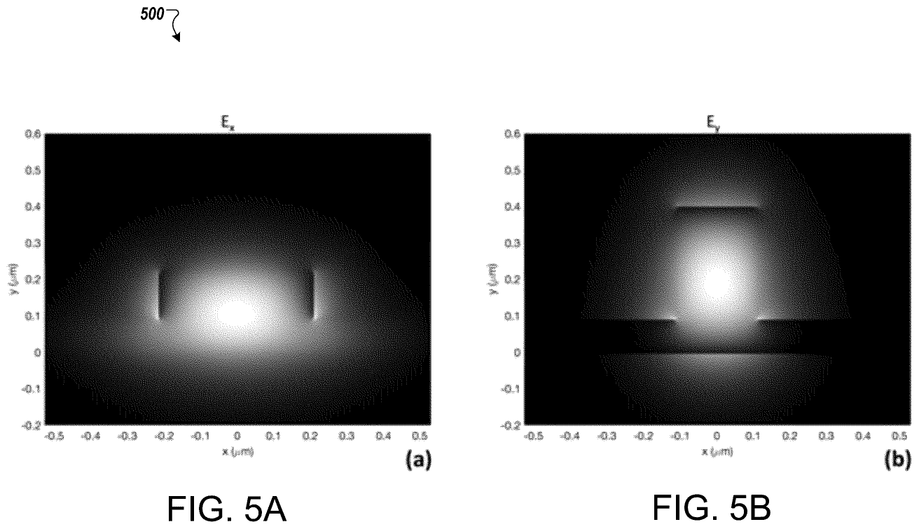

FIGS. 5A and 5B show calculated TE and TM modes in silicon rib waveguides, respectively. FIG. 5A shows an example of calculated modes of a conventional silicon phase modulator using TE-polarized light. In particular, FIG. 5A shows the magnitudes of the x-component of the electric field. FIG. 5B shows an example of calculated modes of a silicon phase modulator using TM-polarized light, according to implementations of the present disclosure. FIGS. 5A and B show the magnitudes of the x and z components, as defined in FIGS. 4A and C, respectively, of the electric field.

As shown, there is significant light in the slab in FIG. 5A but very little light in the slab in FIG. 5B. Thus the slab in FIG. 5B can have significantly higher doping near the rib and thus significantly lower series resistance.

As discussed above, the waveguide rib dimensions can be different in the examples of FIGS. 5A and 5B to facilitate TE or TM transmission. In both cases, the slab thickness is 90 nm. However, in FIG. 5A, the waveguide rib height and rib width are 220 nm and 420 nm, respectively, whereas in FIG. 5B the waveguide rib height and rib width are 400 nm and 220 nm, respectively. The waveguide of FIG. 5A is a typical modulator waveguide configured for TE-polarized light. As discussed above, in such a configuration, a guided TM mode will leak into the slab, because the effective index of the TM 2D rib mode is lower than the effective index of the TE 1D slab mode (see Table 1, below).

By contrast, the waveguide of FIG. 5B is able to guide a TM mode without leakage into the slab, because the waveguide rib is taller and narrower. Having a taller waveguide rib increases the effective index of the TM 2D waveguide mode above that of the TE 1D slab mode, as seen in Table 1.

TABLE 1
Effective mode indices, for a wavelength of λ = 1310 nm.

| | Waveguide configured | Waveguide configured |
|---|---|---|
| | for TE-polarized light | for TM-polarized light |
| | (420 nm × 220 nm) | (220 nm × 400 nm) |
| TE 1D slab (90 nm) | 2.25 | |
| TE 2D waveguide | 2.70 | 2.47 |
| TM 2D waveguide | 2.13 | 2.58 |

Implementations of modulators according to the present disclosure which are configured for TM-polarized light can provide various technical advantages (e.g., as compared to typical modulators configured for TE-polarized light). For example, the doping in the slab can be increased significantly and/or higher doping can be placed closer to the rib. In some implementations, a doping concentration can be increased by a value within a range of 5×10¹⁷ to 1×10¹⁹ (e.g., increased within a range of 1×10¹⁸ to 1×10¹⁹) dopants or activated dopants per cm³ in a first portion of the slab that is within a range of 50 nm to 500 nm (e.g., 100 nm) of a nearest sidewall of the rib, as compared to a second portion of the slab that is farther than 100 nm from the nearest sidewall of the rib. Moreover, as noted above, the reduced rib resistance resulting from non-uniform vertical doping profiles can reduce the rib resistance, instead of or in addition to reduced resistance based on increased slab doping. Based on the increased slab doping concentration and/or non-uniform vertical doping profile in the rib, some implementations of the present disclosure can provide approximately 3.8 times lower series resistance as compared to a typical modulator that is configured for TE-polarized light. The reduced series resistance can increase modulation bandwidth (decrease switching time) and decrease loss.

Another advantage, associated with implementations having geometries configured for TM transmission, is that the phase modulation efficiency can be increased for a given voltage and a given modulator length. This is a consequence of TM-polarized light being more confined horizontally in the waveguide rib, perpendicular to the depletion region, thus resulting in a larger effective index change for a given voltage change.

A further advantage, associated with implementations having non-uniform vertical doping profiles in the waveguide rib, is that capacitance per unit length can be decreased, increasing modulation bandwidth (decreasing switching time) (e.g., as compared to waveguides having uniform vertical doping profiles in the waveguide rib).

Yet another advantage, associated with implementations having rib width in the ranges discussed above, is that sidewall loss can be reduced (e.g., as compared to waveguides having narrower ribs) while retaining high modulation efficiency (e.g., as compared to waveguides having wider ribs).

Some modulator implementations according to the present disclosure can be configured to mitigate potential technical challenges. For example, in modulators configured for TM-polarized light, because the waveguide rib is configured to be taller and thinner (as compared with waveguide ribs of typical modulators designed for TE-polarized light), there may be increased series resistance along the vertical edges of the rib, connecting to the top of the waveguide. To mitigate such resistance, some embodiments include a waveguide rib that is only a small amount taller than the threshold value 0.85λ/n that makes the effective TM 2D rib index higher than the TE 1D slab effective index. For example, in some implementations, the waveguide rib height is 350 nm and the waveguide rib width is 220 nm, for a 90-nm slab configured to transmit 1310-nm wavelength light.

Another potential challenge is that the capacitance of the p-n junction of the waveguide (e.g., semiconductor junction diodes 212 and 214 in FIG. 2) may be increased, as a consequence of the depletion region being taller. However, the fringing fields contribute significantly to the capacitance in these structures, and consequently the capacitance increase is sublinear to the height increase. For example, increasing the waveguide rib height by a factor of 2 results in an increase of the capacitance by only a factor of approximately 1.5. In addition, as discussed above, the capacitance increase can be at least partially mitigated by doping an upper portion of the rib less, or not at all, compared to a lower portion of the rib, effectively reducing a height of the depletion region and/or increasing a width of the depletion region in the upper portion of the rib.

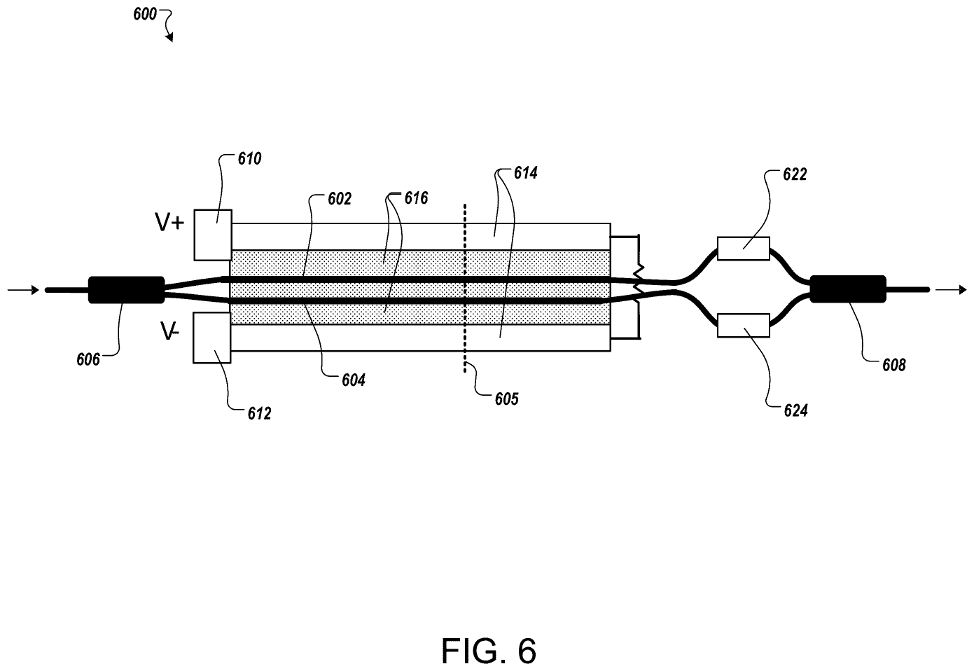

FIGS. 6-9 relate to modulators according to some implementations of the present disclosure. These modulators can include any of the rib waveguides described above with respect to FIGS. 4C-4H. For example, these modulators can include one or more rib waveguides having a non-uniform vertical doping profile, having dimensions configured for TM light transmission, and/or having a rib width in a range from 250 nm to 400 nm or 300 nm to 400 nm to reduce sidewall loss. In contrast with the modulator design shown in FIG. 2, the modulators of FIGS. 6-9 do not include a bias voltage connection between the waveguides, resulting in significantly smaller series resistance between electrodes, and thus even higher bandwidth of modulation. Furthermore, in some implementations according to FIGS. 6-9, the modulators implement waveguide structures that vary in height so as to mitigate detrimental optical coupling between the closely-spaced waveguides.

The features described with reference to FIGS. 6-9 can help improve upon the structure of the modulator of FIG. 2 in various aspects. For example, the presence of DC bias connection 228 in FIG. 2 increases the physical distance of the semiconducting (e.g., silicon) region 238 between the semiconductor junction diodes 212 and 214. This results in significant electrical series resistance in the semiconducting region 238 that connects the semiconductor junction diodes 212 and 214.

Furthermore, the semiconducting regions 240 and 242 in FIG. 2 (which connect each of semiconductor junction diodes 212 and 214 with their respective electrodes 216 and 218) are p-doped semiconducting material, which has higher resistance than n-doped semiconducting material (for the same optical absorption). This results in significant electrical series resistance in the semiconducting regions 240 and 242 between electrodes 216 and 218 and the semiconductor junction diodes 212 and 214.

Consequently, the total electrical series resistance between electrodes 216 and 218 in FIG. 2 can significantly attenuate the voltage along the modulator 200 due to charging and discharging of the diode capacitance. Furthermore, this attenuation typically increases as modulation frequency increases. The resulting RF loss along the modulator 200 can detrimentally impact the bandwidth of the modulator 200.

FIG. 6 illustrates an example of a top view of a modulator 600 according to implementations of the present disclosure.

The modulator 600 is based on an MZI implementation which includes two optical transmission paths 602 and 604, optical splitter 606, and optical combiner 608. The modulator 600 further includes terminals, such as terminal 610 and terminal 612, through which voltages can be applied. The voltages travel along RF transmission line 614, which is connected to semiconducting structure 616 via electrodes that apply respective voltages, and resulting electric fields, across one or both of the optical transmission paths 602 and 604. In some implementations, an optical phase rotator may be implemented between the input of modulator 600 and the optical transmission paths 602 and 604, which rotates a phase of the input light so that quasi-TM light propagates in the optical transmission paths 602 and 604.

The optical transmission paths 602 and 604 can include rib waveguides, such as waveguide 420 and/or waveguide 450.

In contrast to the modulator 100 of FIG. 1, the modulator 600 does not implement any DC bias connection between the two optical transmission paths 602 and 604. This enables the two optical transmission paths 602 and 604 to be more closely-spaced together, thus reducing electrical series resistance therebetween. For example, in some implementations, the distance between the waveguides of the two optical transmission paths 602 and 604 is less than 0.5 μm for at least a portion of the longitudinal direction of the optical transmission paths 602 and 604. In some implementations, the distance between the waveguides is less than 2.0 μm for at least a portion of the longitudinal direction of the optical transmission paths 602 and 604. In some implementations, the distance between the waveguides is within a range of 0.1 μm to 2.0 μm for at least a portion of the longitudinal direction of the optical transmission paths 602 and 604. In some implementations, the distance between the waveguides is defined as the distance between the inner sidewalls of the two waveguides, at a given point along a longitudinal direction of the modulator 600 (e.g., at a point 605 in FIG. 6).

However, because the two optical transmission paths 602 and 604 are more closely spaced, there is risk of more significant detrimental optical coupling between light in optical transmission path 602 and light in optical transmission path 604. To mitigate such optical coupling, in some implementations, the waveguide of one of the optical transmission paths (602 or 604) is designed to have a greater height than the waveguide of the other path (e.g., by at least 10 nm), at the same distance along the length of the modulator 600. This helps ensure that the light traveling in the waveguides of optical transmission paths 602 and 604 are not phase matched, thus mitigating optical coupling between the two waveguides.

An alternative way to understand the importance of using different waveguide heights is to look at the two eigenmodes of the coupled waveguides of optical transmission paths 602 and 604. If the waveguides have equal heights, then the lowest order eigenmode is the even eigenmode, and the second lowest eigenmode is the odd eigenmode. In such a scenario, no differential modulation can occur. However, if one waveguide is sufficiently taller than the other, then the lowest order eigenmode consists of light that is predominantly in the taller waveguide, and the second lowest eigenmode is predominantly in the shorter waveguide. This enables differential modulation to occur despite the closely-spaced waveguides. For example, in some implementations, the waveguide of the one of the optical transmission paths 602 or 604 is taller by at least 10 nm or at least 40 nm than the waveguide of the other optical transmission path. In some implementations, the waveguide height difference is within a range of 40 nm to 120 nm.

Furthermore, in such implementations, the height variation of the two waveguides may be exchanged along the modulator 600, to help ensure that the total length of the taller portions in each waveguide are equal, and also that the total length of the shorter portions in each waveguide are equal. In the example of FIG. 6, moving from the left to right, the waveguide of the first optical transmission path 602 is taller than the waveguide of the second optical transmission path 604, and then becomes shorter than the waveguide of the second optical transmission path 604 (alternatively, the waveguide of the first optical transmission path 602 may start shorter and become taller). There may be one such exchange in relative heights in the middle of modulator 600, but in some implementations, additional height exchanges can be included, e.g., as long as the distance between height exchanges is significantly longer than the beat length between the two eigenmodes in the two waveguides, which is typically 10 μm. This helps mitigate optical coupling between the two waveguides. In some implementations, an odd number of exchanges is preferred, since this will help ensure that the beginning and end transitions cancel each other out.

Although the description of FIG. 6, above, provides an example of a modulator 600 with variable-height waveguides in the two optical transmission paths 602 and 604, in other implementations, the waveguides may have constant height along the length of the modulator 600.

Furthermore, although the description of FIG. 6 provided an example of a modulator 600 without a physical DC bias connection, in some implementations, a DC bias connection may be implemented between the two optical transmission paths 602 and 604, but through a high impedance. For example, in some implementations, the high impedance is achieved with an impedance greater than 1 kohm. As another example, in some implementations, the high impedance is achieved with an impedance greater than 100 ohm. In such scenarios of a DC bias connection through a high impedance, a current would be generated by the voltage difference between (i) the external voltage and (ii) the voltage that would be between the optical transmission paths 602 and 604 if there were no applied external voltage. This generated current would be less than the diode leakage current plus any photo-generated current in the diodes, and thus the circuit would act primarily as if there were no applied external DC bias voltage (e.g., similar to a true floating voltage). Therefore, it should be appreciated that implementations of the present disclosure, such as those shown in FIGS. 6-9 in which there is no physical DC bias connection, can also be implemented with a DC bias connection but through a high impedance.

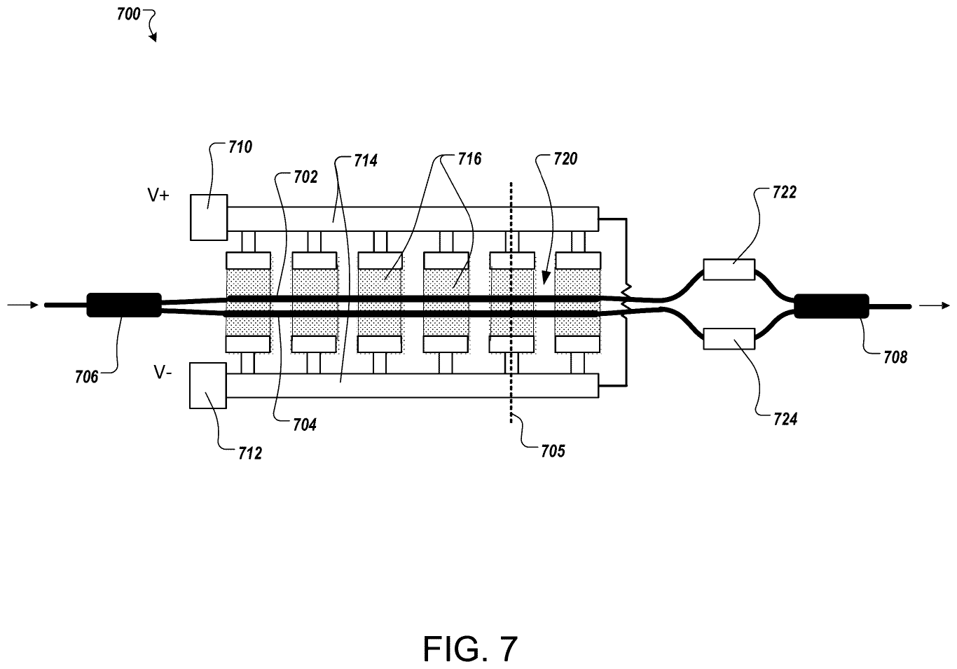

The modulator 600 implements an example of a continuous traveling-wave structure, in which the RF transmission line 614 is continuously connected to the semiconducting structure 616. Alternatively, a segmented traveling-wave structure can be implemented, as described with reference to FIG. 7, below.

FIG. 7 illustrates another example of a top view of a modulator 700 according to implementations of the present disclosure. The modulator 700 is an example of an implementation of a segmented traveling-wave structure.

The modulator 700 is also based on an MZI implementation which includes two optical transmission paths 702 and 704, optical splitter 706, and optical combiner 708. The modulator 700 further includes terminals, such as terminal 710 and terminal 712, through which voltages can be applied. The optical transmission paths 702 and 704 can include rib waveguides, such as waveguide 420 and/or waveguide 450. The voltages travel along RF transmission line 714, which is connected to a semiconducting structure 716 via electrodes that apply respective voltages, and resulting electric fields, across one or both of the optical transmission paths 702 and 704. The modulator 700 also does not implement any DC bias connection between the two optical transmission paths 702 and 704, which reduces the distance therebetween. For example, in some implementations, the distance between the waveguides of the two optical transmission paths 702 and 704 is less than 0.5 μm for at least a portion of the longitudinal direction of the optical transmission paths 702 and 704. In some implementations, the distance between the waveguides is less than 2.0 μm for at least a portion of the longitudinal direction of the optical transmission paths 702 and 704. In some implementations, the distance between the waveguides is within a range of 0.1 μm to 2.0 μm for at least a portion of the longitudinal direction of the optical transmission paths 702 and 704. In some implementations, the distance between the waveguides is defined as the distance between the inner sidewalls of the two waveguides, at a given point along a longitudinal direction of the modulator 700 (e.g., at a point 705 in FIG. 7).

The differences between modulator 600 of FIG. 6 and modulator 700 of FIG. 7 arise from the configuration of the semiconducting structure (616, 716) and the manner in which the RF transmission line (614, 714) is connected to the semiconducting structure (616, 716). Modulator 600 of FIG. 6 implements a continuous traveling wave structure in which RF transmission line 614 is continuously directly connected to the semiconducting structure 616. By contrast, modulator 700 of FIG. 7 implements a segmented traveling wave structure in which RF transmission line 714 is intermittently connected to segments of the semiconducting structure 716, with intermittent regions 720 along the optical transmission paths 702 and 704 in which there is no semiconducting structure. This structure of modulator 700 can also be referred to as a capacitively loaded traveling wave structure, and has an advantage of providing an additional degree of freedom in implementing the RF transmission line 714, e.g., of the average capacitance per unit length of the RF transmission line 714. A lumped-element modulator can also benefit from the techniques disclosed herein.

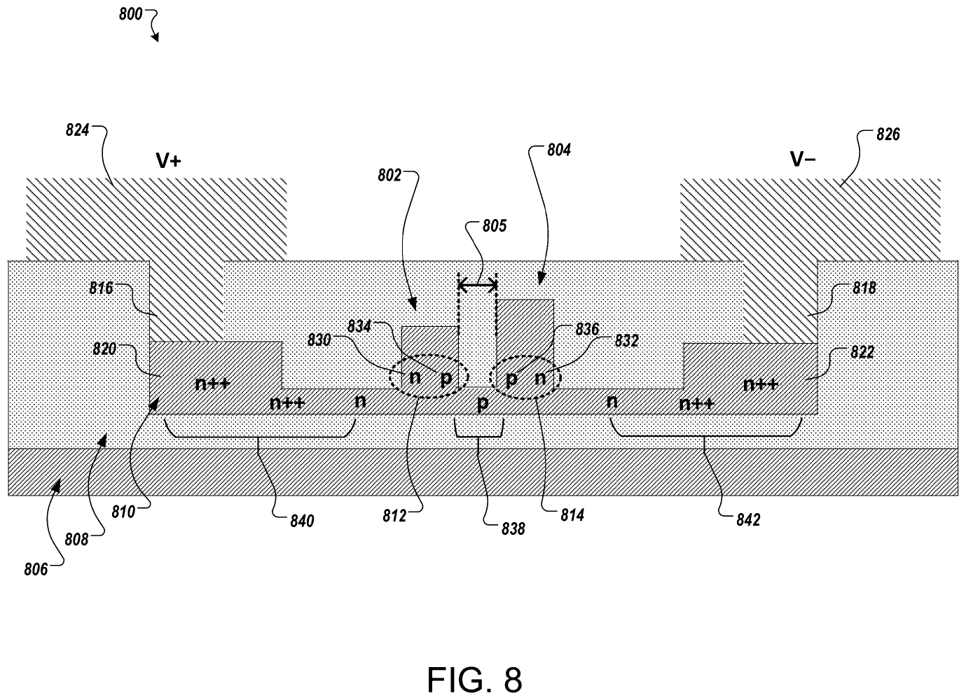

Furthermore, in some implementations of modulator 700, the waveguides of optical transmission paths 702 and 704 have different heights in different sections of the modulator 700, similar to the configuration of the waveguides in modulator 600 of FIG. 6. Further details of the height variation of the waveguides are provided below with respect to FIG. 8.

FIG. 8 illustrates an example of a cross section of a modulator 800 according to implementations of the present disclosure (e.g., a cross section at point 605 of modulator 600 of FIG. 6 or a cross at point 705 of modulator 700 of FIG. 7). In particular, the modulator 800 of FIG. 8 is an example of a differential, close-spaced design in which one waveguide is taller than the other.

The cross-section of modulator 800 shows details of the MZI structure. The MZI includes a first optical waveguide 802 and a second optical waveguide 804. The optical waveguides 802 and 804 can be implemented, for example, as silicon ribbed waveguides on top of a slab. In some implementations, the modulator 800 includes a substrate 806 (e.g., a silicon substrate) an insulating structure 808 (e.g., a dielectric, such as an oxide), and a semiconducting structure 810 (e.g., a silicon layer which includes optical waveguides 802 and 804). In some implementations, one or both of the waveguides 802, 804 has one or more non-uniform vertical doping profiles, and/or has a rib width configured to reduce sidewall loss. For example, the waveguides 802, 804 can be waveguide 420 and/or waveguide 450.

In some implementations, as discussed in regards to FIGS. 6 and 7, above, one of the optical waveguides 802 and 804 is taller than the other optical waveguide. For example, in FIG. 8, the second optical waveguide 804 is taller by at least 10 nm or at least 40 nm than the first optical waveguide 802. In some implementations, the waveguide height difference is within a range of 40 nm to 120 nm.

Each of the optical waveguides 802 and 804 includes a semiconductor junction. The semiconductor junction diodes can be implemented, for example, by a PIN (p-type/intrinsic/n-type) junction diode or a p/n junction diode. In modulator 800, a P/N junction is implanted into each of the optical waveguides 802 and 804 (e.g., into lower portions of the ribs of the waveguides 802 and 804), forming a diode in each waveguide. These diodes are shown as first semiconductor junction diode 812 and second semiconductor junction diode 814.

The modulator 800 also includes electrodes 816 and 818 (e.g., metal electrodes) which are in physical contact with the silicon layer 810. In some implementations, the electrodes 816 and 818 are in physical contact with n-doped contact regions 820 and 822 of the silicon layer 810. The electrodes 816 and 818 may be formed, for example, by etching the insulator layer 808 and forming metal (e.g., tungsten, copper, and/or aluminum) contacts. The modulator 800 may also include metal layers 824 and 826 on top of the electrodes 816 and 818. In some implementations, the metal layers 824 and 826 may form segments of an RF transmission line (e.g., RF transmission line 114 in FIG. 1). In some implementations, the p-doped regions may instead be n-doped regions, and vice-versa, in modulator 800 (e.g., so that contact regions 820 and 822 are n-doped instead of p-doped).

There are numerous differences between modulator 800 and modulator 200 of FIG. 2.

Most notably, modulator 800 does not implement any DC bias voltage connection between semiconductor junction diodes 812 and 814 (as compared to modulator 200 which implements DC bias connection 228). Instead, the semiconductor junction diodes 812 and 814 are connected in series with opposite polarity (with anodes 834 and 836 connected together). This ensures that a continuous current can never flow through the semiconductor junction diodes 812 and 814. This configuration enables the voltages across the two semiconductor junction diodes 812 and 814 to naturally self-adjust to ensure that the diodes 812 and 814 remain reverse-biased, despite variations in modulation voltages (e.g., V+ and V−) that may be applied at electrodes 816 and 818. Implementing a floating voltage between the semiconductor junction diodes 812 and 814 automatically biases the diodes 812 and 814 at the most efficient point of the modulator in terms of phase shift per volt, which is where the diodes 812 and 814 are just below turn-on. In some implementations, this phase shift per volt is the “gain” of the modulator.

Another difference between modulator 800 and modulator 200 of FIG. 2 is that the polarities of semiconductor junction diodes 812 and 814 are flipped, as compared with modulator 200. In particular, semiconductor junction diodes 812 and 814 have their respective (p-doped) anodes 834 and 836 closer to the center of modulator 800, and their respective (n-doped) cathodes 830 and 832 closer to the edges of modulator 800. As such, the semiconducting region 838 between the semiconductor junction diodes 812 and 814 is p-doped, while semiconducting regions 840 and 842 (connecting each of semiconductor junction diodes 812 and 814 with their respective electrodes 816 and 818) are n-doped.

These aforementioned differences can provide numerous technical advantages for modulator 800, as compared to modulator 200 of FIG. 2. One advantage is that the absence of a DC bias voltage connection in modulator 800 enables the two optical waveguides 802 and 804 to be implemented significantly closer to each other, as compared to modulator 200 of FIG. 2. This enables significant reduction in the size of semiconducting region 838 connecting semiconductor junction diodes 812 and 814, which significantly reduces the electrical series resistance between semiconductor junction diodes 812 and 814. For example, in some implementations, the distance (denoted as 805 in FIG. 8) between the two optical waveguides 802 and 804 is less than 0.5 μm. In some implementations, the distance 805 between the two optical waveguides 802 and 804 is less than 2.0 μm. In some implementations, the distance 805 between the two optical waveguides 802 and 804 is within a range of 0.1 μm to 2.0 μm. In some implementations, the distance 805 between waveguides may be defined as the distance between the inner sidewalls of the two waveguides, at a given point along the longitudinal direction of the modulator 800 (e.g., measured at a cross section of the modulator 800 as shown in FIG. 8).

Another advantage is that, since p-doped silicon has a higher resistivity than n-doped silicon (for the same optical absorption), higher-resistivity p-doped material is used in the smaller semiconducting region 838 (between semiconductor junction diodes 812 and 814), and lower-resistivity n-doped material is used in the larger semiconducting regions 840 and 842 (connecting semiconductor junction diodes 812 and 814 with electrodes 816 and 818). Alternatively, in some implementations, n-doped material can be used in the smaller semiconducting region 838, and p-doped material can be used in the larger semiconducting regions 840 and 842.

As a result, the total series resistance between the electrodes 816 and 818 is significantly reduced, thus significantly improving bandwidth and speed of the modulation.

Although the lack of a DC bias voltage connection in modulator 800 takes away a degree of freedom in the ability to adjust the amount of reverse bias in semiconductor junction diodes 812 and 814, such limitations are, in some scenarios, outweighed by the significant benefits offered by the configuration of modulator 800, such as improved bandwidth and speed of modulation.

The modulators according to implementations of the present disclosure can be used in many applications. For example, one application is a high-speed optical intensity modulator to generate intensity-modulated direct-detection (IM-DD) formats such as non-return-to-zero (NRZ) or pulse amplitude modulation (PAM). Another application is to use the modulator in conjunction with a second modulator with a 90-degree relative phase shift as part of a larger interferometer to generate more complex modulation formats for coherent detection, such as quadrature phase-shift keying (QPSK) modulation or quadrature amplitude modulation (QAM). For example, this can be achieved by an in-phase/quadrature (IQ) modulator structure that includes nested modulators, with each of the two branches of a modulator (the outer modulator) implementing another modulator (the inner modulators). In some implementations, phase shifters can be implemented that set 180-degree and 90-degree phase differences for the inner and outer modulators, respectively. Each modulator in such a nested modulator structure can be implemented as described in the present disclosure.

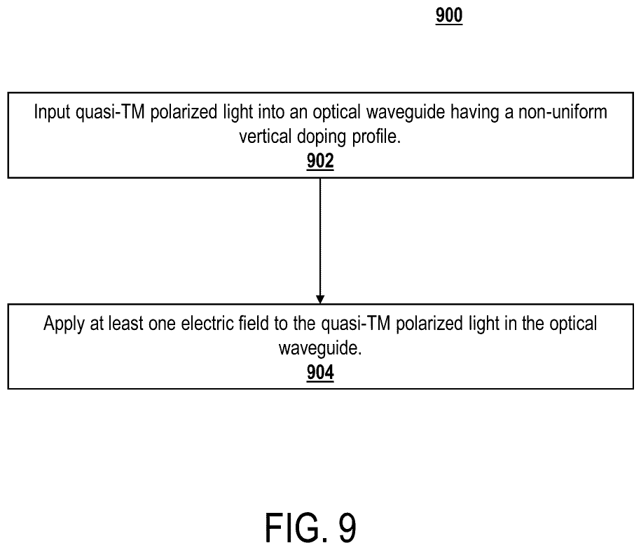

FIG. 9 is a flowchart illustrating an example of a method 900 of modulating quasi-TM polarized light, according to implementations of the present disclosure. The method 900 may be performed using a waveguide as disclosed herein, e.g., waveguide 420 or waveguide 450.

The method 900 includes inputting quasi-TM polarized light into an optical waveguide having a non-uniform vertical doping profile (902). For example, the optical waveguide can be a rib waveguide, and a doping concentration in a lower portion of the rib can be higher than a doping concentration in an upper portion of the rib.

The method 900 further includes applying at least one electric field to the quasi-TM polarized light in the optical waveguide (904). For example, a p/n or PIN semiconductor junction can be formed in the waveguide, where the p-dopant, the n-dopant, or both has the non-uniform vertical doping profile. The electric field can be applied using one or more electrodes electrically coupled to the semiconductor junction, e.g., using the electrode structure described with respect to modulator 100, modulator 200, modulator 600, modulator 700, or modulator 800. The electric field can induce a phase shift in the quasi-TM polarized light, e.g., for use in optical signal modulation. Any of the control operations described with respect to use of modulator 100, modulator 200, modulator 600, modulator 700, or modulator 800 can be performed in conjunction with or using the method 900.

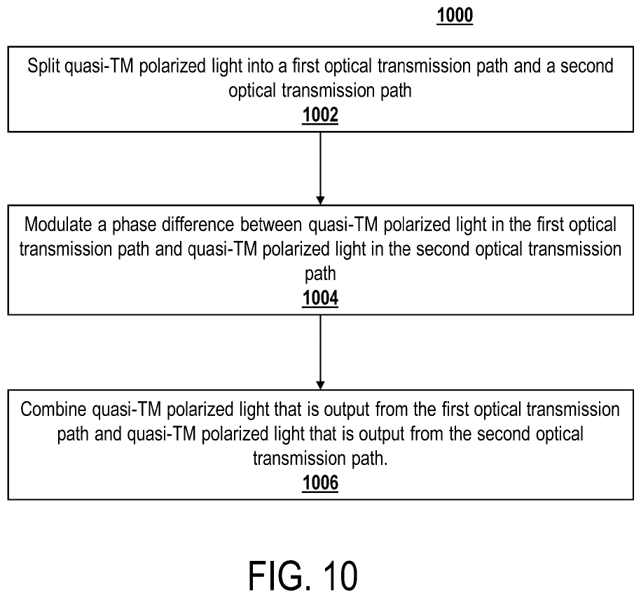

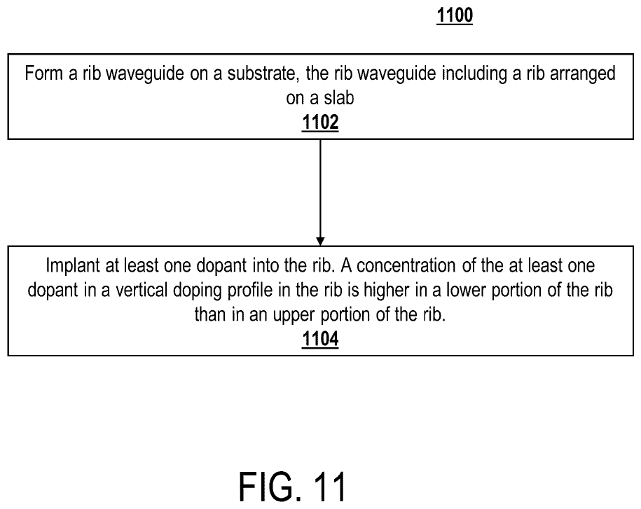

FIG. 10 is a flowchart illustrating an example of a method 1000 of modulating a quasi-TM polarized optical signal, according to implementations of the present disclosure. The method 1000 can be performed by using a modulator as disclosed herein. For example, the method 1000 can be performed using modulator 100, modulator 200, modulator 600, modulator 700, or modulator 800. A modulator used for performing the method 1000 can include one or more rib waveguides, such as waveguide 420 and/or waveguide 450. For example, the rib waveguide can have at least one non-uniform vertical doping profile and/or can have a rib width in a range from 250 nm to 400 nm or 300 nm to 400 nm.

The method 1000 includes splitting quasi-TM polarized light into a first optical transmission path and a second optical transmission path (1002). In some implementations, an optical phase rotator may be implemented at the input of the modulator, which rotates a phase of the input light so that quasi-TM light propagates in the optical transmission paths.

The method 1000 further includes modulating a phase difference between quasi-TM polarized light in the first optical transmission path and quasi-TM polarized light in the second optical transmission path (1004). For example, voltages over semiconductor junction diodes in rib waveguides in one or both transmission paths can be adjusted to modulate the phase difference. In some implementations, the phase difference is modulated without applying a bias voltage between the first optical transmission path and the second optical transmission path. In some implementations, the phase difference is modulated without applying a bias voltage through an impedance less than 1 kΩ or less than 100Ω between the first optical transmission path and the second optical transmission path. In some implementations, the phase difference between the quasi-TM polarized light in the first optical transmission path and the quasi-TM polarized light in the second optical transmission path is modulated while maintaining finite depletion regions in semiconductor junction diodes in each of the first optical transmission path and the second optical transmission path. For example, this modulation can be performed using the floating anode structure of modulators discussed above.

The method 1000 further includes combining quasi-TM polarized light that is output from the first optical transmission path and quasi-TM polarized light that is output from the second optical transmission path (1006).

FIG. 11 illustrates an example of a method 1100 for manufacturing a silicon-photonic optical modulator. The optical modulator includes one or more waveguides. For example, the optical modulator can be modulator 100, modulator 200, modulator 600, modulator 700, or modulator 800.

The method 1100 includes forming a rib waveguide on a substrate, the rib waveguide including a rib arranged on a slab (1102). For example, forming the rib waveguide can include performing one or more etching, lithography, deposition, anneal, oxidation, and/or material growth steps to form the rib arranged on the slab. For example, the rib and the slab can be composed of silicon (e.g., crystalline silicon and/or another form of silicon) on a substrate, such as a semiconductor substrate, in some cases with an intervening dielectric layer as shown in FIGS. 2 and 8. The rib waveguide can have any of the geometric and material characteristics described with respect to waveguides 420 and 450 and FIGS. 2 and 8.

The method 1100 further includes implanting at least one dopant into the rib (1104), such that the rib is doped in an ion implantation process. The at least one dopant can form the p-type and/or the n-type region in the rib, resulting in formation of a semiconductor junction diode in the rib. The at least one dopant is implanted such that a concentration of the at least one dopant in a vertical doping profile in the rib is higher in a lower portion of the rib than in an upper portion of the rib. Implantation of both donors and acceptors can be performed using suitable masking.

For example, in some implementations, the at least one dopant is implanted by directing a beam of the at least one dopant into the rib from a side of the substrate on which the rib is disposed, e.g., in a generally vertically downward direction. For example, to implant a dopant into the rib 422 of FIG. 4C, a beam of the dopant can be directed into the rib in the −z direction, from above the rib 422.

With suitable selection of the beam energy, the dopant can be implanted such that the concentration of the at least one dopant in the vertical doping profile in the rib is higher in the lower portion of the rib than in an upper portion of the rib. For example, a high acceleration energy can be used, to cause implanted dopant ions to penetrate deep into the rib. In some implementations, the acceleration energy is between 50 keV and 230 keV, energies that have been found to provide suitable doping profiles for obtaining the advantages discussed herein. In some implementations, an acceleration energy between 100 keV and 200 keV can further provide advantageous doping profiles, e.g., providing a balance between deep implantation of the dopant and a broad distribution of the dopant for effective modulation.

Other methods of forming the waveguides discussed herein are also within the scope of this disclosure. For example, in some implementations, the waveguides are doped by dopant diffusion or are grown with dopant atoms already included in the rib and/or slab, etc.

While this disclosure contains many specific implementation details, these should not be construed as limitations on the scope of any invention or of what may be claimed, but rather as descriptions of features that may be specific to particular implementations of particular inventions. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results.

What is claimed is:

1. A silicon-photonic optical modulator comprising:
an optical input; and
an optical waveguide that is connected to the optical input and that is configured to propagate quasi-transverse-magnetic (quasi-TM) polarized light, wherein the optical waveguide is configured as a rib waveguide that comprises a rib arranged on a slab,
wherein the rib comprises at least one dopant,
wherein an average concentration of the at least one dopant in a vertical doping profile in a lowermost portion of the rib is larger than an average concentration of the at least one dopant in the vertical doping profile in an uppermost portion of the rib,
wherein the uppermost portion of the rib has a height that is between 20% and 80% of a height of the rib waveguide, and
wherein the lowermost portion of the rib comprises a remainder of the rib below the uppermost portion.

2. The silicon-photonic optical modulator of claim 1, wherein the average concentration of the at least one dopant in the lowermost portion is at least 1.5 times the average concentration of the at least one dopant in the uppermost portion.

3. The silicon-photonic optical modulator of claim 2, wherein the average concentration of the at least one dopant in the lowermost portion is at least two times the average concentration of the at least one dopant in the uppermost portion.

4. The silicon-photonic optical modulator of claim 1, wherein the height of the uppermost portion is between 35% and 65% of the height of the rib waveguide.

5. The silicon-photonic optical modulator of claim 1, wherein:
the average concentration of the at least one dopant in the lowermost portion is between 10¹⁷ cm⁻³ and 10¹⁸ cm⁻³, and the average concentration of the at least one dopant in the uppermost portion is less than 5×10¹⁶ cm⁻³.

6. The silicon-photonic optical modulator of claim 1, wherein the at least one dopant comprises a first dopant in a first lateral portion of the rib and a second dopant in a second lateral portion of the rib, the second lateral portion opposite the first lateral portion,
wherein the first lateral portion and the second lateral portion form a semiconductor junction diode.

7. The silicon-photonic optical modulator of claim 6, wherein a concentration of the first dopant in a first vertical doping profile in the first lateral portion of the rib is higher in the lower portion of the rib than in the upper portion of the rib, and
wherein a concentration of the second dopant in a second vertical doping profile in the second lateral portion of the rib is higher in the lower portion of the rib than in the upper portion of the rib.

8. The silicon-photonic optical modulator of claim 6, comprising an electrode configured to apply an electric field to the semiconductor junction diode.

9. The silicon-photonic optical modulator of claim 8, comprising a semiconductor contact region to which the electrode makes contact,
wherein a height of the semiconductor contact region is greater than a height of the slab.

10. The silicon-photonic optical modulator of claim 1, wherein an effective refractive index of a TM polarization two-dimensional (2D) guided mode in the rib waveguide is greater than all effective refractive indexes of transverse-electric (TE) polarization one-dimensional (1D) guided modes in the slab.

11. The silicon-photonic optical modulator of claim 1, wherein the optical waveguide is a first optical waveguide,
wherein the silicon-photonic optical modulator comprises a Mach-Zehnder interferometer comprising the first optical waveguide and a second optical waveguide,
wherein the first optical waveguide comprises a first semiconductor junction diode based on the at least one dopant, and
wherein the second optical waveguide comprises a second semiconductor junction diode based on the at least one dopant.

12. A silicon-photonic optical modulator comprising:
an optical input;
an optical waveguide configured to receive light from the optical input, wherein the optical waveguide is configured as a rib waveguide that comprises a rib arranged on a slab, and wherein the rib waveguide has a geometry that is configured to propagate quasi-transverse-magnetic (quasi-TM) polarized light; and
an electrode configured to apply an electric field across the rib waveguide,
wherein a width of the rib waveguide is in a range from 250 nm to 400 nm.

13. The silicon-photonic optical modulator of claim 12, wherein a height of the rib waveguide is greater than the width of the rib waveguide.

14. The silicon-photonic optical modulator of claim 12, wherein a height of the rib waveguide is in a range of 300 nm to 400 nm, and
wherein a thickness of the slab is in a range of 50 nm to 150 nm.

15. The silicon-photonic optical modulator of claim 12, wherein the width of the rib waveguide is in a range from 250 nm to 360 nm.

16. The silicon-photonic optical modulator of claim 12, wherein the optical waveguide is a first rib waveguide, and wherein the silicon-photonic optical modulator comprises a second rib waveguide, and
wherein a gap between the first rib waveguide and the second rib waveguide is less than 500 nm wide.

17. The silicon-photonic optical modulator of claim 16, wherein a height of the first rib waveguide is greater than a height of the second rib waveguide by at least 10 nm in at least part of the silicon-photonic optical modulator.

18. A method of manufacturing a silicon-photonic optical modulator, comprising:
forming a rib waveguide on a substrate, the rib waveguide comprising a rib arranged on a slab; and
implanting at least one dopant into the rib,
wherein an average concentration of the at least one dopant in a vertical doping profile in a lowermost portion of the rib is larger than an average concentration of the at least one dopant in the vertical doping profile in an uppermost portion of the rib,
wherein the uppermost portion of the rib has a height that is between 20% and 80% of a height of the rib waveguide, and
wherein the lowermost portion of the rib comprises a remainder of the rib below the uppermost portion.

19. The method of claim 18, wherein implanting the at least one dopant into the rib comprises directing a beam of the at least one dopant into the rib in a direction from a side of the substrate on which the rib is disposed, towards the substrate.

20. The method of claim 19, wherein the beam has an acceleration energy in a range from 50 keV to 230 keV.
